(19) United States
(12) Patent Application Publication
(10) Pub. No.: US 2019/0066734 A1
(43) Pub. Date: Feb. 28, 2019

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Chiaki Kaneko, Yokohama-shi (JP)

(21) Appl. No.: 16/113,354

(22) Filed: Aug. 27, 2018

(30) Foreign Application Priority Data
Aug. 31, 2017 (JP) 2017-167232

(51) Int. Cl. G11B 27/036; H04N 9/74; G11B 27/34

(52) U.S. Cl. CPC G11B 27/036; G06F 3/04847; G11B 27/34; H04N 9/74

(57) ABSTRACT

An image processing apparatus includes: a selection unit configured to select one operation mode from a plurality of operation modes including at least a first mode that specifies movement of virtual light for at least one frame of a plurality of frames included in input moving image data and a second mode that specifies movement of the virtual light, which is different from movement of the virtual light specified in the first mode; an acquisition unit configured to acquire parameters of the virtual light based on the selected operation mode; a derivation unit configured to derive parameters of the virtual light, which are set to the plurality of frames, based on acquired parameters of the virtual light; and an execution unit configured to perform lighting processing to add illumination effects by the virtual light to each of the plurality of frames based on derived parameters of the virtual light.

### BACKGROUND OF THE INVENTION

### Field of the Invention

The present invention relates to virtual lighting processing for adding virtual illumination effects to a captured image.

### Description of the Related Art

Conventionally, as a technique relating to virtual lighting processing to add virtual illumination effects to a moving image, a highlight generation technique using three-dimensional space information on an image is known (see Japanese Patent Laid-Open No. 2005-11100). Japanese Patent Laid-Open No. 2005-11100 describes a method of generating a highlight on the surface of an object in an image based on three-dimensional space information on the image by specifying the position and shape of a highlight a user desires to add on the image for two or more key frames in the image (moving image).

The method described in Japanese Patent Laid-Open No. 2005-11100 obtains the position and orientation of a virtual light that follows and illuminates an object by interpolation. However, for a highlight that is generated by a virtual light that moves independently of the movement of an object, it is not possible to obtain the position and shape thereof by interpolation. The virtual light that moves independently of the movement of an object is, for example, the light that moves following a camera having captured an image or the light that exists at a specific position in a scene captured in an image. Consequently, by the method described in Japanese Patent Laid-Open No. 2005-11100, depending on the way of movement of a virtual light, it is necessary for a user to estimate the position and shape of a highlight generated by the virtual light and specify for each frame, and therefore, there is such a problem that much effort and time are required.

Consequently, an objective of the present invention is to make it possible to select the way of movement of a virtual light from a plurality of patterns and to make it possible to simply set the position and orientation of a virtual light that moves in accordance with an operation mode.

### SUMMARY OF THE INVENTION

The image processing apparatus according to the present invention includes: a selection unit configured to select one operation mode from a plurality of operation modes including at least a first mode that specifies movement of a virtual light for at least one frame of a plurality of frames included in input moving image data and a second mode that specifies movement of the virtual light, which is different from the movement of the virtual light specified in the first mode; an acquisition unit configured to acquire parameters of the virtual light based on the operation mode selected by the selection unit; a derivation unit configured to derive parameters of the virtual light, which are set to the plurality of frames, based on the parameters of the virtual light, which are acquired by the acquisition unit; and an execution unit configured to perform lighting processing to add illumination effects by the virtual light to each of the plurality of frames based on the parameters of the virtual light, which are derived by the derivation unit.

Further features of the present invention will become apparent from the following description of exemplary embodiments with reference to the attached drawings.

### BRIEF DESCRIPTION OF THE DRAWINGS

FIG. 1 is a diagram showing a hardware configuration of an image processing apparatus according to a first embodiment;

FIG. 2 is a function block diagram showing an internal configuration of the image processing apparatus according to the first embodiment;

FIG. 3 is a flowchart showing output moving image data generation processing according to the first embodiment;

FIG. 4A and FIG. 4B are diagrams showing an example of a UI screen for performing the setting of a virtual light according to the first embodiment;

FIG. 5A to FIG. 5C are diagrams each showing an example of movement of a virtual light in accordance with an operation mode;

FIG. 6 is a function block diagram showing an internal configuration of an image processing apparatus according to a second embodiment;

FIG. 7 is a diagram showing camera installation states and an example of a relationship between position and orientation information that can be acquired and alternatives of the operation mode;

FIG. 8 is a diagram showing an example of a UI screen for performing the setting to make use of camera installation states and position and orientation information acquired by various sensors;

FIG. 9A to FIG. 9E are diagrams each showing an example of alternative information;

FIG. 10 is a flowchart showing output moving image data generation processing according to the second embodiment;

FIG. 11A to FIG. 11C are diagrams showing an example of a UI screen for performing the setting of a virtual light according to the second embodiment; and

FIG. 12 is a diagram showing an example of a UI screen for performing the setting of a virtual light according to a third embodiment.

### DESCRIPTION OF THE EMBODIMENTS

In the following, embodiments of the present invention are explained with reference to the drawings. The following embodiments do not necessarily limit the present invention and all combinations of features explained in the present embodiments are not necessarily indispensable to the solution of the present invention. Explanation is given by attaching the same symbol to the same configuration.

### First Embodiment

In the present embodiment, information indicating the position and orientation of a virtual light set for the top frame in a range (called an editing range) of frames that are the target of editing in a moving image is propagated to each frame within the editing range in a coordinate space in accordance with an operation mode that specifies movement of the virtual light. Due to this, it is made possible to set a virtual light different in behavior for each operation mode. In the present embodiment, it is possible to select the operation mode of a virtual light from three kinds, that is, a camera reference mode, an object reference mode, and a scene reference mode. Each operation mode will be described later.

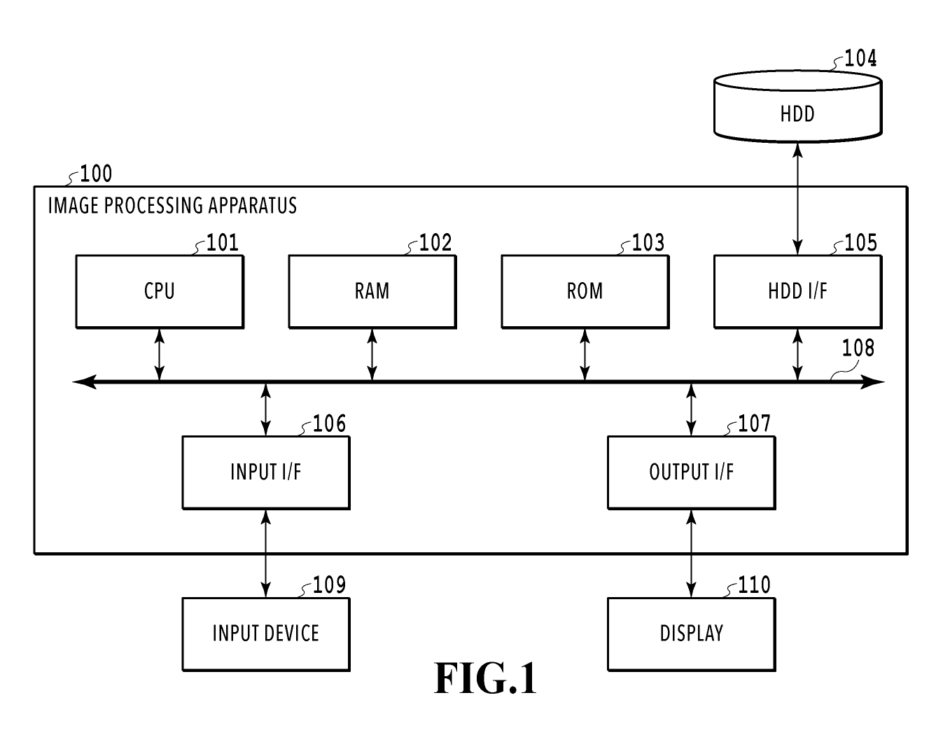

FIG. 1 is a diagram showing a hardware configuration example of an image processing apparatus in the present embodiment. An image processing apparatus 100 includes a CPU 101, a RAM 102, a ROM 103, an HDD 104, an HDD I/F 105, an input I/F 106, an output I/F 107, and a system bus 108.

The CPU 101 executes programs stored in the ROM 103 and the hard disk drive (HDD) 104 by using the RAM 102 as a work memory and controls each unit, to be described later, via the system bus 108. The HDD interface (I/F) 105 is an interface, for example, such as a serial ATA (SATA), which connects a secondary storage device, such as the HDD 104 and an optical disc drive. It is possible for the CPU 101 to read data from the HDD 104 and to write data to the HDD 104 via the HDD I/F 105. Further, it is possible for the CPU 101 to load data stored in the HDD 104 onto the RAM 102 and similarly to save the data loaded onto the RAM 102 in the HDD 104. Then, it is possible for the CPU 101 to execute the data (programs and the like) loaded onto the RAM 102. The input I/F 106 connects an input device 109. The input device 109 is an input device, such as a mouse and a keyboard, and the input I/F 106 is, for example, a serial bus interface, such as USB. It is possible for the CPU 101 to receive various signals from the input device 109 via the input I/F 106. The output I/F 107 is, for example, a video image output interface, such as DVI, which connects a display device, such as the display 110. It is possible for the CPU 101 to send data to the display 110 via the output I/F 107 and to cause the display 110 to produce a display based on the data. In the case where a bidirectional communication interface, such as USB and IEEE 1394, is made use of, it is possible to integrate the input I/F 106 and the output I/F 107 into one unit.

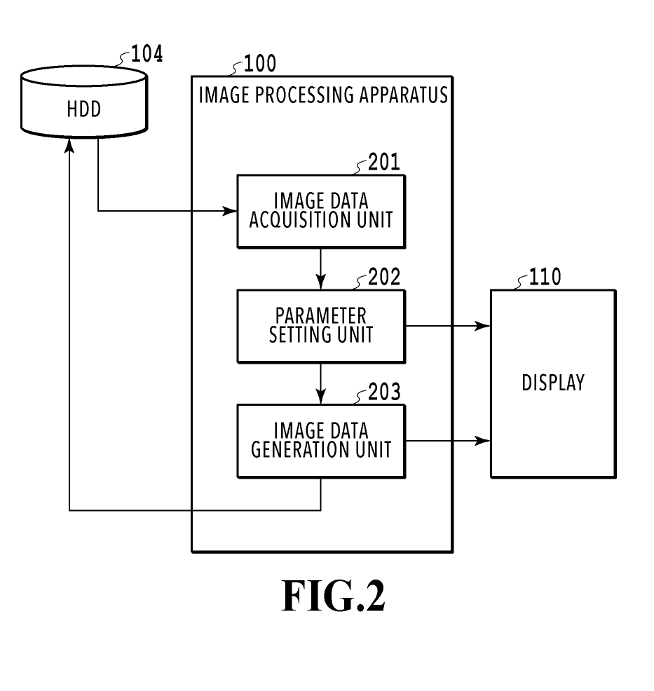

FIG. 2 is a function block diagram showing an internal configuration of the image processing apparatus 100 according to the first embodiment. An image data acquisition unit 201 acquires moving image data including image data (frame image data) corresponding to each of a plurality of frames and three-dimensional information on an object, corresponding to each piece of image data, from the storage device, such as the HDD 104. The three-dimensional information on an object is information indicating the position and shape of an object in the three-dimensional space. In the present embodiment, polygon data indicating the surface shape of an object is used as the three-dimensional information on an object. The three-dimensional information on an object is only required to be capable of specifying the position and shape of an object in a frame image (image indicated by frame image data) and may be, for example, a parametric model represented by a NURBS curve and the like. The acquired moving image data is sent to a parameter setting unit 202 as input moving image data.

The parameter setting unit 202 sets an editing range that is taken to be the target of editing of a plurality of frames included in the input moving image data based on instructions of a user. Further, the parameter setting unit 202 sets the operation mode that specifies movement of the virtual light for the key frame representing the frames within the editing range and the lighting parameters. Details will be described later. The editing range, and the operation mode and the lighting parameters of the virtual light, which are set, are sent to an image data generation unit 203 in association with the input moving image data.

The image data generation unit 203 sets the virtual light for each frame within the editing range in the input moving image data based on the operation mode and the lighting parameters of the virtual light, which are set for the key frame. Further, the image data generation unit 203 generates output frame image data to which lighting by the virtual light is added by using the virtual light set for each frame, the image data of each frame, and the three-dimensional information on an object, corresponding to each piece of image data. Then, the image data (input frame image data) within the editing range in the input moving image data is replaced with the output frame image data and this is taken to be output moving image data. Details of the setting method of the virtual light for each frame and the generation method of the output frame image data will be described later. The generated output moving image data is sent to the display 110 and displayed as well as being sent to the storage device, such as the HDD 104, and stored.

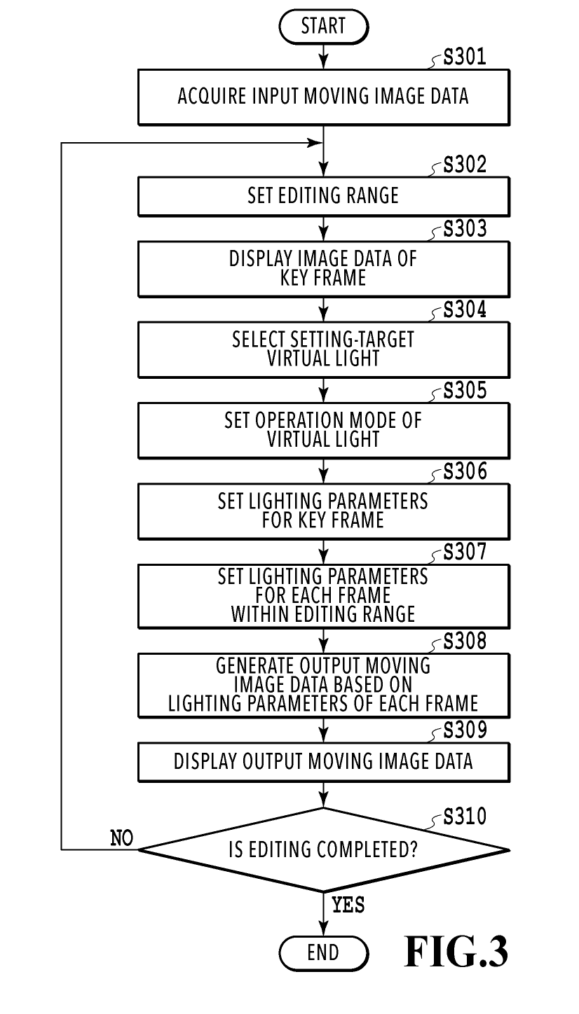

FIG. 3 is a flowchart showing output moving image data generation processing according to the first embodiment. The output moving image data generation processing is implemented by the CPU 101 executing a program that describes the procedure shown in FIG. 3 and which can be executed by a computer after reading the program from the ROM 103 or the HDD 104 onto the RAM 102.

At step S301, the image data acquisition unit 201 acquires input moving image data from the storage device, such as the HDD 104, and delivers the acquired input moving image data to the parameter setting unit 202.

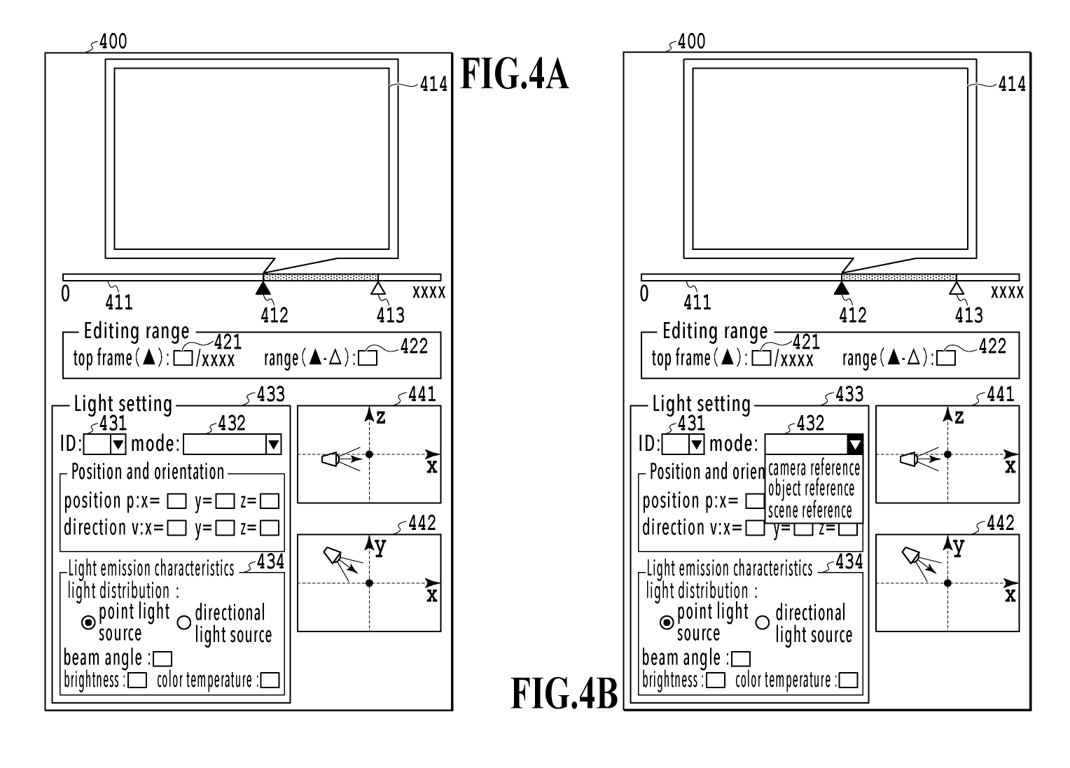

At step S302, the parameter setting unit 202 sets an editing range for the input moving image data received from the image data acquisition unit 201. In the present embodiment, the editing range is indicated by time t0 of the top frame and elapsed time dt from time t0. In FIG. 4A and FIG. 4B, a user interface (UI) screen 400 for performing the setting of a virtual light for input moving image data is shown. A time axis 411 is the time axis for all frames of the input moving image data and “0” on the time axis indicates the time of the top frame and “xxxx” indicates the time of the last frame. Markers 412 and 413 indicate the positions of the top frame and the last frame of the editing range, respectively. A top frame input box 421 and a range input box 422 are input boxes for specifying the top frame and the editing range, respectively. The parameter setting unit 202 displays the UI screen 400 shown in FIG. 4A on the display 110 and sets the values input to the top frame input box 421 and the range input box 422 respectively as time t0 and time dt. It may also be possible to set the top frame of the editing range by using a frame ID identifying individual frames in place of time t0, or to set the number of frames included within the editing range in place of elapsed time dt. Further, it may also be possible to set one of frames within the editing range and the number of successive frames before or after the frame as a start point as the editing range.

At step S303, the parameter setting unit 202 takes the top frame (that is, the frame at time t0) of the editing range set at step S302 as a key frame and outputs image data of the key frame onto the display 110. Then, in an image display box 414 on the UI screen 400, the image of the key frame is displayed. It is possible for a user to perform the setting of a virtual light, to be explained later, by operating the UI screen 400 via the input device 109.

At step S304, the parameter setting unit 202 determines the virtual light selected by a user in a virtual light selection list 431 on the UI screen 400 as a setting target of the operation mode and lighting parameters, to be explained later. In the case where a pull-down button (button in the shape of a black inverted triangle shown in FIG. 4A) is pressed down in the virtual light selection list 431, a list of virtual lights that can be selected as a setting target is displayed and it is possible for a user to select one from the list. Here, the virtual light that can be selected as a setting target is, for example, a new virtual light and the virtual light already set for the key frame being displayed in the image display box 414. It may also be possible to select a virtual light by using a radio button or a checkbox, to select a virtual light by inputting a virtual light ID identifying individual virtual lights, and so on, in addition to selecting a virtual light from the list described above. Further, in the case where it is possible to specify a setting-target virtual light, it may also be possible to select a virtual light via another UI screen. Furthermore, it may also be possible to enable a plurality of virtual lights to be selected at the same time.

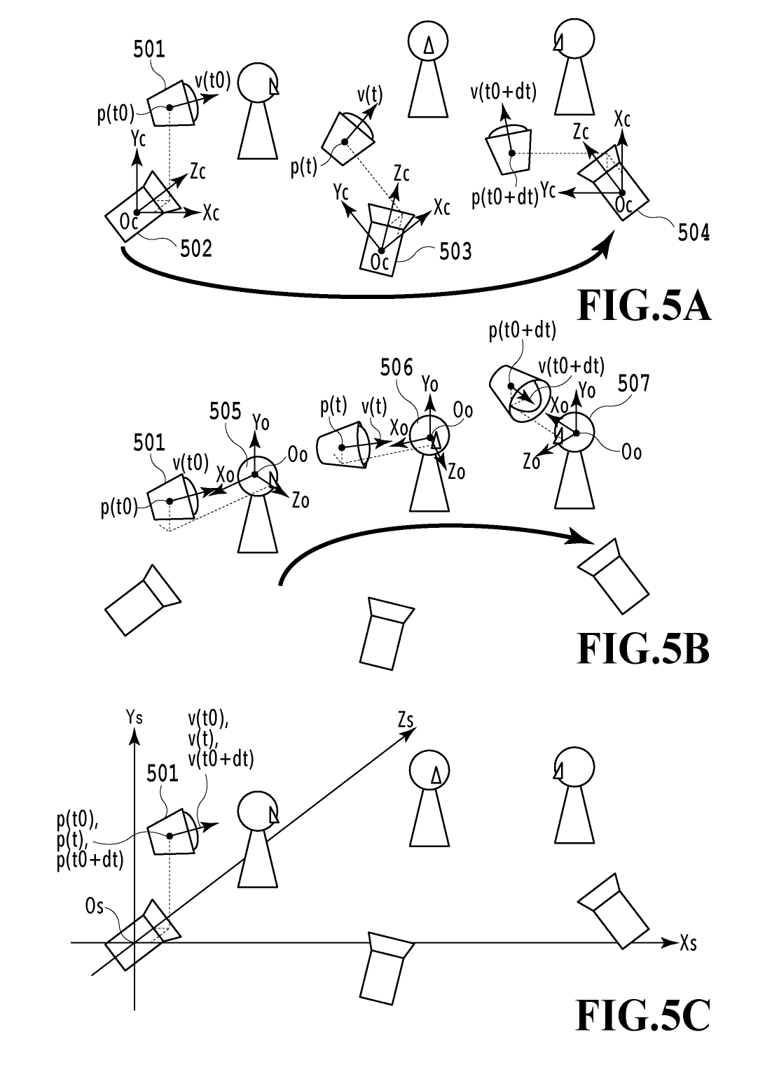

At step S305, the parameter setting unit 202 sets the operation mode selected by a user in an operation mode selection list 432 on the UI screen shown in FIG. 4A as the operation mode of the virtual light selected at step S304. In the present embodiment, as described above, it is possible to select the operation mode from the three kinds of the operation mode: the camera reference mode, the object reference mode, and the scene reference mode. FIG. 5A to FIG. 5C show examples of the operation of the virtual light in each mode. The camera reference mode shown in FIG. 5A is a mode in which a virtual light 501 moves following a camera. That is, a mode in which the position of the virtual light 501 is determined in accordance with the position of a camera. In FIG. 5A, each of cameras 502, 503, and 504 indicates a camera having captured a frame image at time t0, t, and t0+dt, respectively. Further, an arrow in FIG. 5A indicates the way the virtual light 501 moves following the camera. The object reference mode shown in FIG. 5B is a mode in which the virtual light 501 moves following an object. That is, a mode in which the position of the virtual light 501 is determined in accordance with the position of an object. In FIG. 5B, each of objects 505, 506, and 507 indicates the state of the object at time t0, t, and t0+dt, respectively. An arrow in FIG. 5B indicates the way the virtual light 501 moves following the object. The scene reference mode shown in FIG. 5C is a mode in which the virtual light 501 exists in a scene (image capturing site) independently and the movement thereof does not depend on the movement of a camera or an object. That is, a mode in which the position of the virtual light 501 is determined irrespective of the position of a camera or an object. These operation modes are displayed in a list at the time of the pull-down button of the operation mode selection list 432 being pressed down and it is possible for a user to select one of the operation modes. FIG. 4B shows a display example at the time the pull-down button of the operation mode selection list 432 is pressed down. It is sufficient to be capable of specifying one operation mode and it may also be possible to select an operation mode by using a radio button and the like, in addition to selecting an operation mode from the pull-down list.

In the case where the operation mode of the selected virtual light is the object reference mode, the object that is taken to be the reference is also set. For example, on the key frame image displayed in the image display box 414, the area corresponding to the object desired to be taken as the reference (hereinafter, called reference object) is selected by a user using an input device, such as a mouse, and image data of the area is stored as reference object information. The reference object information is only required to be information capable of specifying the position and orientation of the object on the frame image and the information may be set by using a method other than that described above.

At step S306, the parameter setting unit 202 sets lighting parameters relating to the virtual light selected at step S304 for the key frame. Here, the lighting parameters are parameters indicating the position and orientation (position and direction in the three-dimensional space) and light emission characteristics (color, brightness, light distribution characteristics, irradiation range, and so on). In the present embodiment, as the information indicating the position and orientation of the virtual light at time t (hereinafter, called position and orientation information), position coordinates p (t) and a direction vector v (t) represented in the camera coordinate system at time t are used. Here, the camera coordinate system is a coordinate system based on the position and orientation of a camera having captured a frame image. In the case where the example in FIG. 5A is used, the coordinate system in which each of positions Oc of the camera at time t0, t, and t0+dt is taken to be the origin and the horizontally rightward direction, the vertically upward direction, and the direction toward the front of the camera are taken to be an Xc-axis, a Yc-axis, and a Zc-axis respectively represents the camera coordinate system at each time.

In a position and orientation input box 433 on the UI screen 400, items for setting position and orientation information p (t0) and v (t0) of the virtual light for the key frame are arranged. In the example shown in FIG. 4A, it is possible to set position coordinates (x, y, z values) and a direction (x, y, z values) at time t0 of the virtual light as position and orientation information. Further, in a light emission characteristics setting box 434 on the UI screen 400, items for setting light emission characteristics of the virtual light are arranged. In the example shown in FIG. 4A, it is possible to set the kind of light distribution (point light source, directional light source), the beam angle, brightness, and color temperature as light emission characteristics. In a display box 441, an image indicating the setting state in the xz-coordinate system of the virtual light is displayed and in a display box 442, an image indicating the setting state in the xy-coordinate system of the virtual light is displayed.

At step S307, the image data generation unit 203 sets lighting parameters relating to the virtual light selected at step 5304 for each frame within the editing range set at step SS02. At this time, the image data generation unit 203 sets lighting parameters for each frame based on the operation mode set at step S305 and the lighting parameters set for the key frame at step S306. In the present embodiment, it is assumed that the operation mode and the light emission characteristics of the virtual light are constant within the editing range. Consequently, it is assumed that for all the frames within the editing range, the same operation mode as the operation mode set at step S305 and the same light emission characteristics as the light emission characteristics set at step S306 are set. Further, the position and orientation information on the virtual light is set based on the position and orientation information set for the key frame at step S306 in accordance with the operation mode set at step S305. In the following, the setting of the position and orientation information for each key frame within the editing range is explained for each operation mode of the virtual light.

### Camera Reference Mode

For the virtual light whose operation mode is the camera reference mode, the position and orientation information in each frame is set so that the relative position relationship for the camera having captured the frame image is maintained within the editing range. Position coordinates p and a direction vector v of the light represented in the camera coordinate system at the time of capturing a certain frame image indicate the relative position coordinates and direction for the camera having captured the frame image. Consequently, in the case where the camera reference mode is selected at step S305, the same values as those of the position coordinates p (t0) and the direction vector v (t0) of the virtual light set for the key frame at step S306 are set for each frame within the editing range. Specifically, the same values as those of the position coordinates p (t0) and the direction vector (t0) are set as the position coordinates p (t) and the direction vector v (t) of the virtual light in each frame.

### Object Reference Mode

For the virtual light whose operation mode is the object reference mode, the position and orientation information in each frame is set so that the relative position relationship for the reference object is maintained within the editing range.

First, the position coordinates p (t0) and the direction vector v (t0) of the virtual light set for the key frame (represented in the key frame camera coordinate system) at step S306 are converted into values po (t0) and vo (t0) in the object coordinate system. Due to this, the position coordinates p (t0) and the direction vector v (t0) based on the operation mode set at step S305 are acquired. The object coordinate system is a coordinate system based on the position and orientation of the reference object. The objects 505, 506, and 507 shown in FIG. 5B are the reference objects at times t0, t, and t0+dt, respectively. Then, the object coordinate system at each time is a coordinate system in which a position Oo of the reference object at each time is taken to be the origin, and the horizontally rightward direction, the vertically upward direction, and the direction toward the front of the reference object are taken to be an Xo-axis, a Yo-axis, and a Zo-axis, respectively.

The position coordinates and the direction vector represented in the object coordinate system indicate the relative position coordinates and the direction for the reference object. Because of this, in the case where the position coordinates and the direction of the virtual light are represented in the object coordinate system in each frame in each frame within the editing range, it is sufficient to perform the setting so that those values become the values in the key frame. Due to this, the relative position relationship of the virtual light for the reference object is kept also in a frame other than the key frame. Consequently, the same values as those of the position coordinates po (t0) and the direction vector vo (t0) represented in the object coordinate system in the key frame are set to position coordinates po (t) and a direction vector vo (t) of the virtual light represented in the object coordinate system in each frame within the editing range. Then, the values derived by converting the position and orientation information po (t) (=po (t0) and vo (t) (=vo (t0)) into those in the camera coordinate system in each frame are set as the position coordinates p (t) and the direction vector v (t) of the virtual light in each frame.

Generally, coordinate conversion from coordinates (x, y, z) represented in a certain coordinate system (XYZ coordinate system) into coordinates (x′, y′, z′) represented in another coordinate system (X′Y′Z′ coordinate system) is expressed by an expression below.

$$( \begin{matrix}{x}^{′} \\ {y}^{′} \\ {z}^{′} \\ 1\end{matrix} ) = ( \begin{matrix}{X}_{x}^{′} & {X}_{y}^{′} & {X}_{z}^{′} & 0 \\ {Y}_{x}^{′} & {Y}_{y}^{′} & {Y}_{z}^{′} & 0 \\ {Z}_{x}^{′} & {Z}_{y}^{′} & {Z}_{z}^{′} & 0 \\ 0 & 0 & 0 & 1\end{matrix} ) ( \begin{matrix}1 & 0 & 0 & - {O}_{x}^{′} \\ 0 & 1 & 0 & - {O}_{y}^{′} \\ 0 & 0 & 1 & - {O}_{z}^{′} \\ 0 & 0 & 0 & 1\end{matrix} ) ( \begin{matrix}x \\ y \\ z \\ 1\end{matrix} ) \qquad expression 1$$

Here, (O′x, O′y, O′z) is the coordinates of an origin 0′ in the X′Y′Z′ coordinate system represented in the XYZ coordinate system. (X′x, X′y, X′z), (Y′x, Y′y, Y′z), and (Z′x, Z′y, Z′z) are the unit vectors in the X′-, Y′-, and Z′-axis directions represented in the XYZ coordinate system, respectively. By using expression 1, it is possible to obtain the position coordinates po (t0) and the direction vector vo (t0), which are the position coordinates p (t0) and the direction vector v (t0) in the key frame camera coordinate system converted into those in the object coordinate system. At this time, it is sufficient to use expression 1 by taking the origin Oo and the coordinate axes Xo, Yo, and Zo in the object coordinate system in the key frame (that is, time t0) as O′, X′, Y′, and Z′. Further, it is possible to find conversion from the object coordinate system into the camera coordinate system in each frame as inverse conversion of expression 1 by using the origin Oo and the unit vectors in the directions of the coordinate axes Xo, Yo, and Zo in the object coordinate system represented in the camera coordinate system of each frame.

It may also be possible to acquire the position coordinates and the direction of the reference object in the camera coordinate system (that is, the origin coordinates and the directions of the coordinate axes in the object coordinate system represented in the camera coordinate system) in each frame including the key frame by using any method. For example, it may also be possible to acquire them by template matching using the reference object information stored at step S305 or another motion tracking technique. Acquisition of the position and orientation of an object is not the main purpose of the present invention, and therefore, detailed explanation is omitted.

### Scene Reference Mode

For the virtual light whose operation mode is the scene reference mode, the position and orientation information in each frame is set so that the relative position relationship with the reference position set in a scene is maintained within the editing range. In the present embodiment, the position of the key frame camera is taken as a reference position Os of the scene and the key frame camera coordinate system is used as a reference coordinate system of the scene (hereinafter, called a scene coordinate system). In order to maintain the relative position relationship of the virtual light for the reference position, it is sufficient to consider by replacing the object coordinate system at the time of the object reference mode described previously with the scene coordinate system. However, in the case where the key frame camera coordinate system is used as the scene coordinate system, conversion of position and orientation information from the key frame camera coordinate system into the scene coordinate system is no longer necessary. The reason is that the values of the position coordinates p (t0) and the direction vector v (t0) of the virtual light set for the key frame at step S306 become position coordinates ps (t0) and a direction vector vs (t0) of the virtual light in the scene coordinate system as they are. Then, the values obtained by converting the position and orientation information ps (t0) and vs (t0) into those in the camera coordinate system in each frame are set as the position coordinates p (t) and the direction vector v (t) of the virtual light in each frame. Conversion from the scene coordinate system (that is, key frame camera coordinate system) into the camera coordinate system in each frame is found by expression 1 by using an origin Oc and unit vectors in the directions of coordinate axes Xc, Yc, and Zc in the camera coordinate system in each frame, which are represented in the key frame camera coordinate system. It is possible to acquire the position coordinates and direction of a camera in the key frame camera coordinate system in each frame by using a publicly known camera position and orientation estimation technique. The camera position and orientation estimation technique is not the main purpose of the present invention, and therefore, detailed explanation is omitted.

At step S308, the image data generation unit 203 generates output frame image data for each frame within the editing range set at step S302. At this time, output frame image data to which virtual lighting is added is generated from the input moving image data acquired at step S301 and the lighting parameters of the virtual light. Then, the image data within the editing range in the input moving image data is replaced with the output frame image data and the input moving image data after the replacement is taken to be output moving image data. In the following, a method of generating output frame image data to which illumination effects of the virtual light are added from input frame image data for which the virtual light is set is explained.

First, based on the three-dimensional information on an object and the lighting parameters of the virtual light, an image Gm is generated in which brightness (called virtual reflection intensity) at the time of a polygon making up the object being illuminated by the mth virtual light is recorded as a pixel value. Here, m=0, 1, . . . , M−1. M indicates the number of virtual lights set in the frame. In the following, the above-described image Gm is called a virtual reflection intensity image Gm. In the present embodiment, by using expression 2, which is a general projection conversion formula, vertex coordinates (x, y, z) of a polygon in the three-dimensional space are converted into a pixel position (i, j) on a two-dimensional image. Further, a virtual reflection intensity I corresponding to the vertex is calculated by the Phong reflection model indicated by expression 3 to expression 7 below and stored as a pixel value Gm (i, j) at the pixel position (i, j) of the virtual reflection intensity image Gm. For a pixel corresponding to the inside of the polygon, a value obtained by interpolation from the virtual reflection intensity I corresponding to each vertex making up the polygon is stored.

$$( \begin{matrix}i \\ j \\ d \\ 1\end{matrix} ) = MsMp ( \begin{matrix}x \\ y \\ z \\ 1\end{matrix} ) \qquad expression 2$$

virtual reflection intensity I=ID+IA+IS expression 3

diffuse reflection component ID=Id*kd*(N·L) expression 4

ambient reflection component IA=Ia*ka expression 5

specular reflection component IS=Is*ks*(L·R)̂n expression 6

reflection vector R=−E+2(N·E)N expression 7

In expression 2, Ms and Mp are a screen transformation matrix and a projection transformation matrix, respectively, determined from the resolution of the input frame image and the angle of view of the camera having captured the input frame image. Further, d corresponds to the distance in the direction of depth up to the object at the pixel position (i, j). In expression 3 to expression 7, Id, Ia, and Is are intensities of incident light relating to diffuse reflection, ambient reflection, and specular reflection, respectively. N, L, and E indicate a normal vector, a light vector (vector from vertex toward light source), and an eyesight vector (vector from vertex toward camera), respectively. In the present embodiment, the brightness in the lighting parameters is used as Id, Ia, and Is and the inverse vector of a direction v of the light is used as L. However, in the case where the vertex is outside of the illumination range indicated by the lighting parameters, the values of Id, Ia, and Is are taken to be zero. Further, as a diffuse reflection coefficient kd, an ambient reflection coefficient ka, a specular reflection coefficient ks, and a specular reflection index n in expression 3 to expression 7, it may also be possible to set values associated in advance in accordance with the object, or to set values specified by a user. For the generation of the virtual reflection intensity image Gm explained above, it is possible to make use of common rendering processing in computer graphics. Further, it may also be possible to use a reflection model other than the above-described reflection mode. The rendering processing is not the main purpose of the present invention, and therefore, detailed explanation is omitted.

Next, by using a pixel value F (i, j) at the pixel position (i, j) of the input frame image and the pixel value Gm (i, j) (m=0, 1, . . . , M−1) of the virtual reflection intensity image, a pixel value F′ (i, j) of the output frame image is calculated in accordance with expression below.

F′(i, j)=F(i,j)+G₀(i,j)+. . .G₁(i,j)+ . . . +G_{M-1}(i,j) expression 8

In this manner, the output frame image data is generated. At this time, the output frame image becomes an image in which the brightness of the input frame image is changed in accordance with the position and orientation of the virtual light and the shape of the object.

The generation method of the output frame image data is not limited to that described above and it may also be possible to use another publicly known method. For example, it may also be possible to map the input frame image to the polygon data representing the shape of an object as texture and perform rendering for the state where the texture-attached polygon is illuminated based on the lighting parameters.

At step S309, the image data generation unit 203 outputs and displays the output moving image data on the display 110. At step S310, upon receipt of instructions to complete editing via the input device, the parameter setting unit 202 terminates the series of processing. In the case where there are no instructions to complete editing, the parameter setting unit 202 returns to the processing at step S302 and continues the setting of the light.

By performing the processing control explained above, it is made possible to select the way of movement of the virtual light from a plurality of patterns (plurality of operation modes). Further, it is possible to simply set the position and orientation of the virtual light that moves in accordance with the selected operation mode. Furthermore, it is not necessary for a user to specify the setting of the position and orientation of the virtual light for each frame other than the key frame, and therefore, it is unlikely to impose the work load on a user.

In the case where there exists a virtual light already set for the key frame at step S303, it may also be possible for the various parameters of the virtual light and the image data of the key frame to be sent to the image data generation unit 203. Then, it may also be possible for the image data generation unit 203 to display the image after the change of the lighting on the display 110.

Further, at step S308, it may also be possible to store the input moving image data, the operation characteristics of the set virtual light, and the lighting parameters as editing history data in association with the output moving image data. According to such an aspect, it is made easy to perform reediting of the virtual light for the output moving image data.

### Second Embodiment

In the first embodiment, the method is explained in which a user arbitrarily selects the operation mode. However, depending on the image capturing equipment at the time of image capturing of the input moving image data and the conditions of an object, it is not necessarily possible to always acquire the position and orientation information on an object and a camera. In a frame in which the position and orientation information such as this is not obtained, it becomes difficult to derive the position of the virtual light in the object reference mode or in the scene reference mode. On the other hand, it is not possible for a user to know whether or not the virtual lighting processing succeeds until the output moving image data is displayed and in the case where there is not position and orientation information necessary for the processing, it becomes necessary to perform the work again from the beginning. Consequently, in the present embodiment, an example is explained in which the moving image data is analyzed in advance and the operation mode that can be selected in each frame is limited. In the present embodiment also, as in the first embodiment, it is assumed that the operation mode can be selected from these kinds of operation mode, that is, the camera reference mode, the object reference mode, and the scene reference mode.

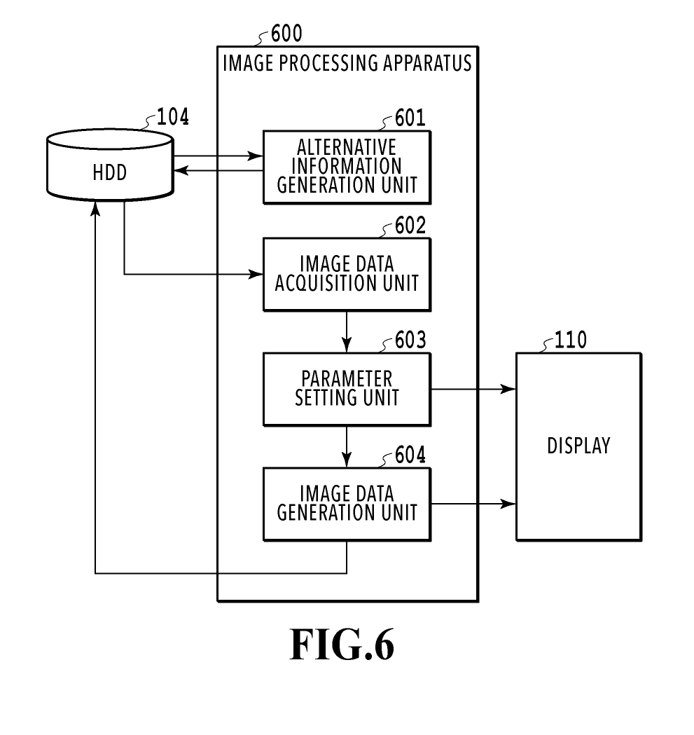

FIG. 6 is a function block diagram showing an internal configuration of the image processing apparatus 100 in the second embodiment. An image data generation unit 604 is the same as the image data generation unit 203 in the first embodiment, and therefore, explanation is omitted. In the following, portions different from those of the first embodiment are explained mainly.

An alternative information generation unit 601 acquires input moving image data from the storage device, such as the HDD 104, and analyzes the input moving image data and generates alternative information. The alternative information is information indicating the operation mode that can be selected in each frame in the moving image. At the time of propagating the position and orientation of the virtual light set in the key frame to each frame within the editing range, in the camera reference mode, the position and orientation information on the object or the camera is not necessary. On the other hand, in the object reference mode or in the scene reference mode, the position and orientation information on the object or the camera in each frame within the editing range is necessary. That is, the camera reference mode can be set for all the frames, but the object reference mode and the scene reference mode can be set only for a frame in which it is possible to acquire the necessary position and orientation information. Consequently, in the present embodiment, the camera reference mode is always added as the alternative of the operation mode and the object reference mode and the scene reference mode are added as the alternative of the operation mode only in the case where it is possible to acquire the necessary position and orientation information. In the following, there is a case where the alternative of the operation mode is represented simply as alternative. The necessary position and orientation information is the three-dimensional position coordinates and the direction of the object or the camera in the case where the virtual light is set as a point light source. However, in the case where the virtual light is set as a directional light source, it is required to be capable of acquiring only the direction as the position and orientation information.

It is possible to determine whether or not the position and orientation information on the object can be acquired by applying template matching using template images of a desired object prepared in advance, a main object extraction technique, or a motion tracking technique, both being publicly known, to all the frames of the input moving image data. For example, in the case where template matching is used, on a condition that the degree of similarity between the template image and the frame image is lower than a threshold value determined in advance, it is possible to determine that the position and orientation information on the object cannot be acquired in the frame.

Further, it is possible to determine whether or not the position and orientation information on the camera can be acquired by applying a publicly known camera position and orientation estimation technique to all the frames of the input moving image data. For example, a re-projection error for the frame image is derived by using the estimated camera position and orientation and the three-dimensional information on the object and in the case where this error is larger than a threshold value determined in advance, it is possible to determine that the position and orientation information on the camera cannot be acquired in the frame image.

It may also be possible to use an output value of an acceleration sensor or a position sensor attached to the object or the camera as part or all of the position and orientation information. In this case, it is also possible to determine that the position and orientation information can always be acquired and it is also possible to determine whether or not the position and orientation information can be acquired based on a signal of detection success or detection failure that is output by various sensors.

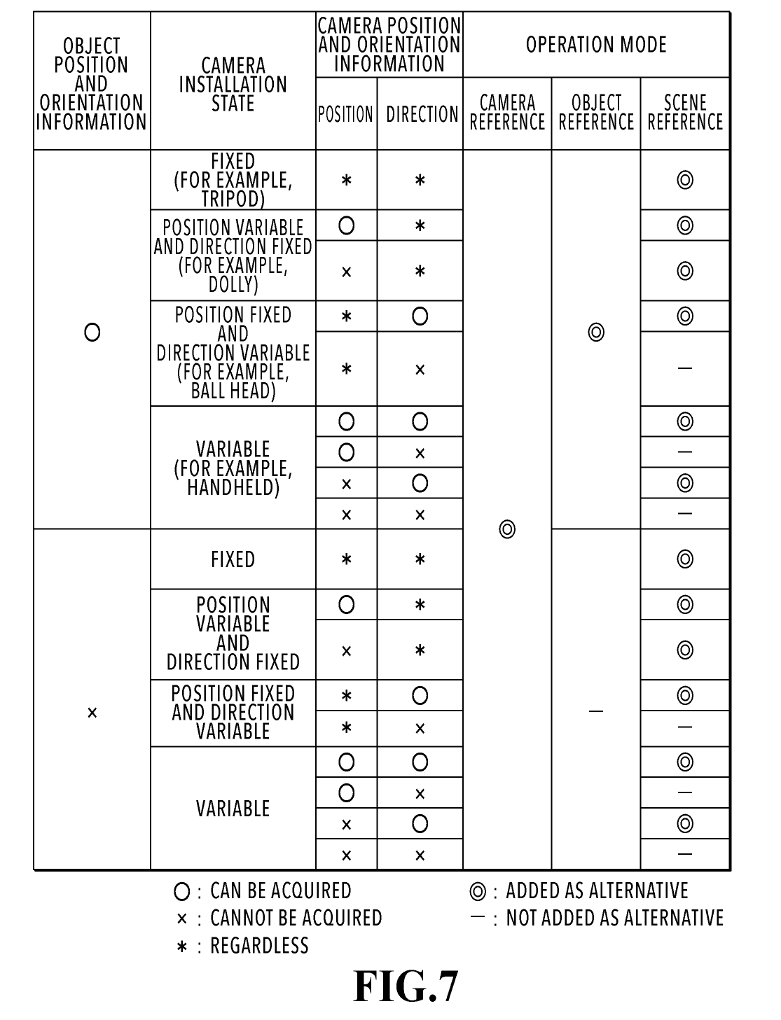

Further, it may also be possible to generate an alternative based on the installation state of the camera. For example, in the case where the camera is set up on a tripod, neither position nor direction changes over time, and therefore, conversion from the scene coordinate system (that is, key frame camera coordinate system) into the camera coordinate system in each frame is no longer necessary. Consequently, the alternative information generation unit 601 always adds the scene reference mode as the alternative. Further, for example, in the case where the camera is set up on a ball head, the position of the camera does not change, and therefore, it is made possible to convert from the scene coordinate system into the camera coordinate system provided that the direction can be acquired as the position and orientation information. Consequently, in this case, the alternative information generation unit 601 adds the scene reference mode as the alternative in accordance with whether or not the direction of the camera can be acquired. Further, for example, in the case where the camera is set up on the linear dolly rail and the direction does not change, the alternative information generation unit 601 adds the scene reference mode as the alternative in accordance with whether or not the position can be acquired. FIG. 7 shows conditions for switching of the operation mode according to the camera installation state and the position and orientation information that can be acquired.

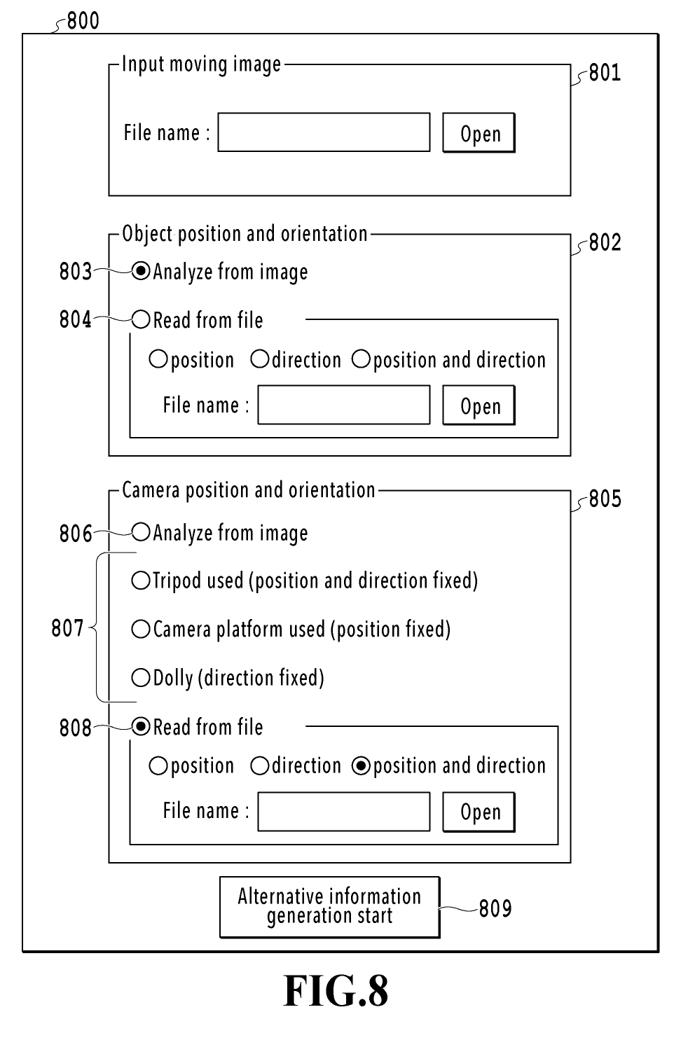

The setting at the time of making use of the camera installation state or the position and orientation information acquired from various sensors is performed by a user via, for example, a UI screen 800 shown in FIG. 8. An input box 801 on the UI screen 800 is a box where a user specifies the file of moving image data for which the user desires to generate alternative information. An input box 802 is a box where a user sets an acquisition method of position and orientation information on an object. In the case of acquiring the position and orientation information on an object by analyzing the moving image data specified in the input box 801, a user selects “Analyze from image (radio button 803)” in the input box 802. Further, in the case of acquiring the position and orientation information on an object by referring to an external file storing output values of various sensors, a user checks “Read from file (radio button 804)” in the input box 802. Then, the user specifies the kind of information to be referred to (“position”, “direction”, or “position and direction”) and the external file. An input box 805 is a box where a user sets the acquisition method of position and orientation information on a camera. In the case of acquiring the position and orientation information on a camera by analyzing the moving image data specified in the input box 801, a user selects “Analyze from image (radio button 806)” in the input box 805. In the case of acquiring the position and orientation information on a camera from the camera installation state, a user selects one of “Tripod used”, “Ball head used”, and “Dolly” by a radio button 807. Further, in the case of acquiring the position and orientation information on a camera by referring to the external file storing output values of various sensors, a user selects “Read from file (radio button 808)” in the input box 805. Then, the user specifies the kind of information to be referred to (“position”, “direction”, or “position and direction”) and the external file. In the case where an Alternative information generation start button 809, which is a button, is pressed down, an image analysis or reading of data from the external file is performed in accordance with the contents of the setting in the input box 802 and the input box 805 and alternative information for the moving image data specified in the input box 801 is generated.

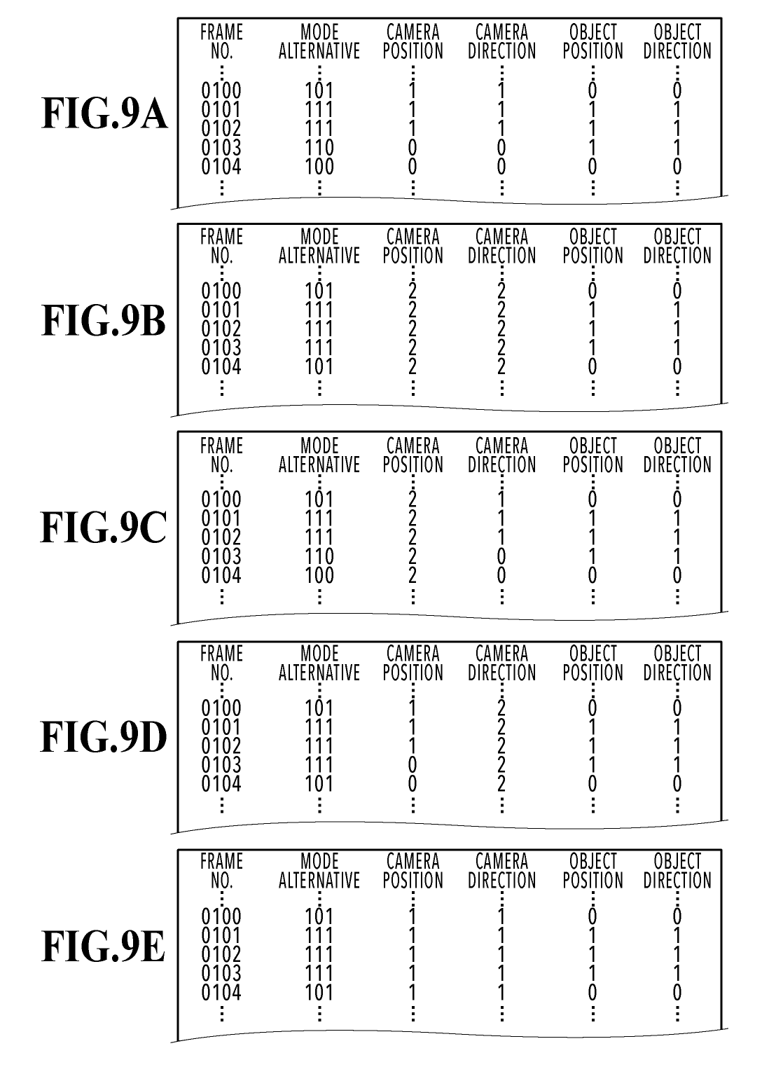

Examples of alternative information that is generated are shown in FIG. 9A to FIG. 9E. In the examples shown in FIG. 9A to FIG. 9E, the alternative of the operation mode for each frame is represented by a three-digit numerical value including 1 (selectable) and 0 (not selectable). Of the three-digit numerical value, the third digit, the second digit, and the first digit indicate selectable or not selectable of the camera reference mode, the object reference mode, and the scene reference mode, respectively. In the alternative information, together with the alternative of the operation mode, information indicating whether or not the position and orientation of a camera or an object can be acquired, or indicating whether the position and orientation do not change is recorded. In the case where the position and orientation of a camera or an object can be acquired, 1 is recorded, in the case where the position and orientation cannot be acquired, 0 is recorded, and in the case where the position and orientation do not change, 2 is recorded. FIG. 9A shows an example of the case where “Analyze from image” is selected for both the object position and orientation and the camera position and orientation. FIG. 9B to FIG. 9E show examples of the cases where “Analyze from image” is selected for the object position and orientation and each of “Tripod used”, “Ball head used”, “Dolly”, and “Read from file (position and direction)” is selected for the camera position and orientation. The generated alternative information is stored in the storage device, such as the HDD 104, in association with the moving image data.

An image data acquisition unit 602 acquires input moving image data including three-dimensional information on an object as in the case with the image data acquisition unit 201 of the first embodiment. However, the image data acquisition unit 602 also acquires the alternative information in association with the input moving image data, in addition to the input moving image data. The acquired various kinds of data are sent to a parameter setting unit 603.

The parameter setting unit 603 sets an editing range for the input moving image data based on instructions of a user as in the case with the parameter setting unit 202 of the first embodiment. Then, the parameter setting unit 603 sets the operation mode and the lighting parameters of the virtual light for the key frame representative of the frames within the editing range. However, the parameter setting unit 603 selects the operation mode from the alternatives indicated by the alternative information in association with the input moving image data and sets the operation mode. The editing range, and the operation mode of the virtual light and the lighting parameters of the virtual light, which are set, are associated with the input moving image data and sent to the image data generation unit 604.

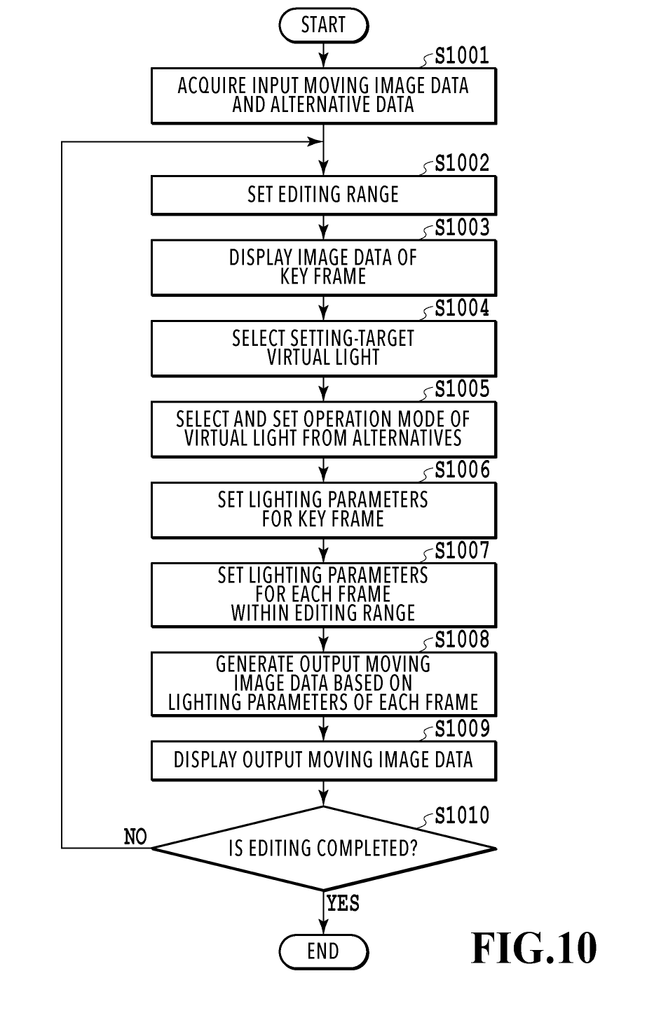

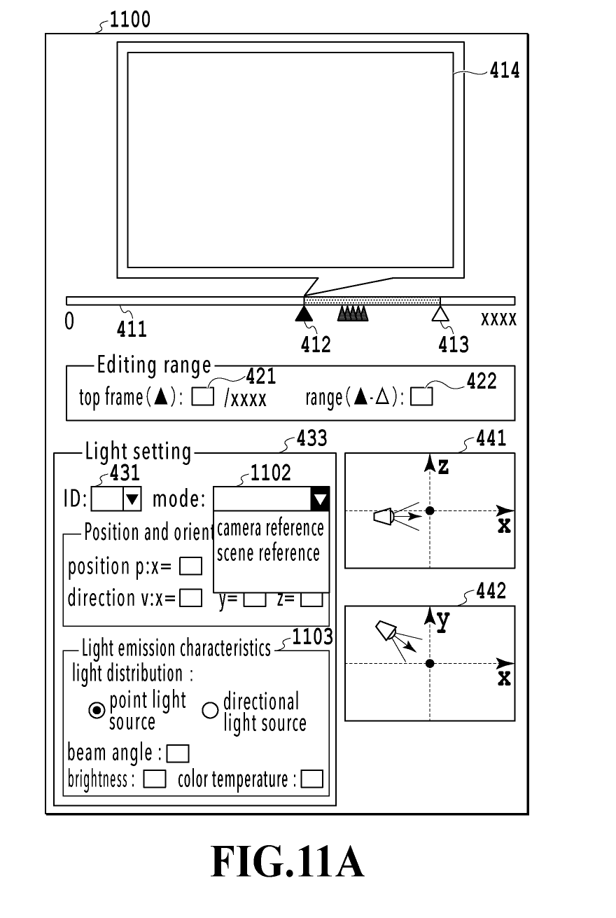

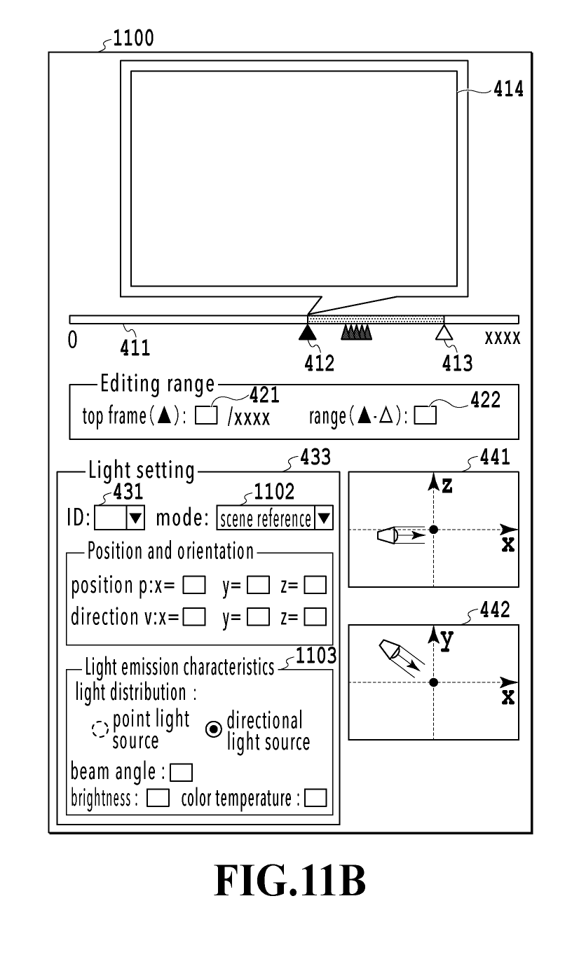

In the following, by using a flowchart shown in FIG. 10, the operation procedure of the editing processing in the image processing apparatus 100 according to the present embodiment is explained.

At step S1001, the image data acquisition unit 602 acquires input moving image data and alternative information from the storage device, such as the HDD 104. It is assumed that the alternative information is generated in advance by the alternative information generation unit 601. The processing at steps S1002 to S1004 is the same as the processing at steps S302 to S304, and therefore, explanation is omitted.

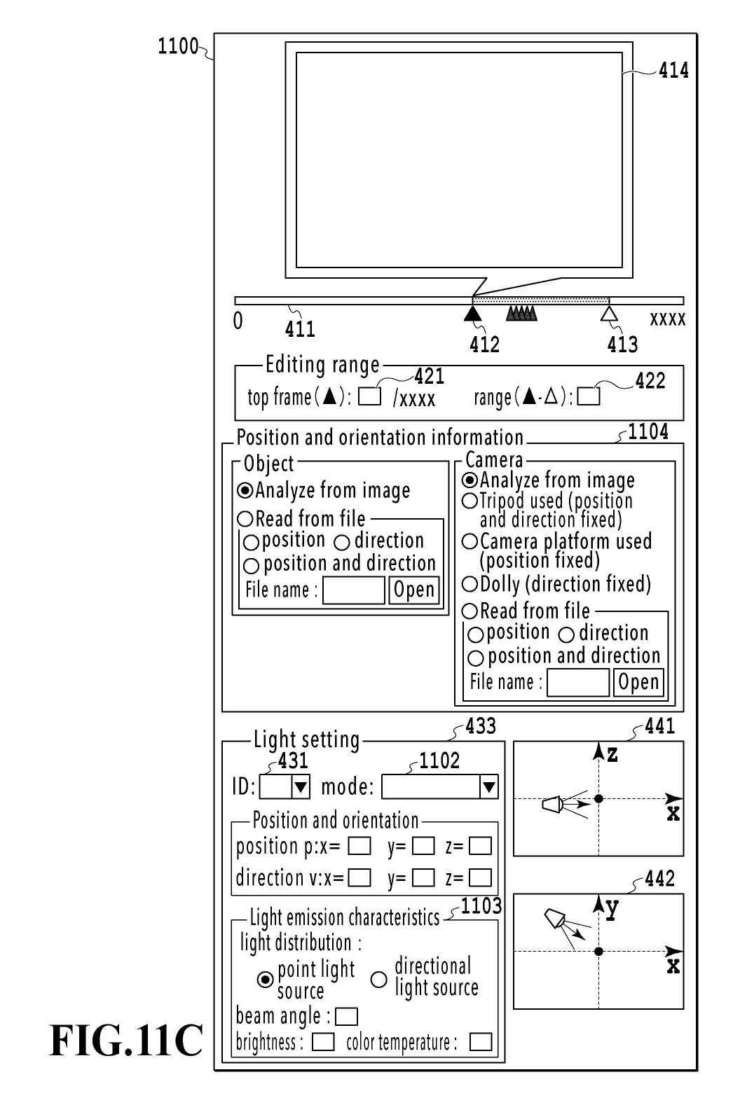

At step S1005, the parameter setting unit 603 presents the alternatives corresponding to the key frame to a user via an operation mode selection list 1102 on a UI screen 1100 shown in FIG. 11A based on the alternative information acquired at step S1001. Then, the operation mode selected by a user via the operation mode selection list 1102 is set as the operation mode of the virtual light selected at step S1004. FIG. 11A shows a display example in the case where the frame of No. 0104 in FIG. 9D is set. At this time, in the case where the operation mode selected by a user is not included in the alternatives in any frame within the editing range, the parameter setting unit 603 prompts a user to set the operation mode again or to set the editing range again. In the case where a user is prompted to set the editing range again, it may also be possible to notify the user of the frame in which the operation mode selected by the user is not selectable as reference information. For example, it may also be possible to notify the user of the frame ID or the time corresponding to the frame, or notify the user of the position of the frame on the time axis by using a cursor 1101 shown in FIG. 11A. In this case, it is made easier for the user to grasp the range of the frame in which a desired operation mode can be set, and therefore, re-setting of the editing range is made easy.

Further, in the case where the object reference mode or the scene reference mode is selected by a user, on a condition that only the direction is acquired as the position and orientation information on the camera, as the light emission characteristics of the virtual light, “point light source” is made not selectable. An example of the case where scene reference is selected in FIG. 11A is shown in FIG. 11B. As described above, FIG. 11A and FIG. 11B show display examples in the case where the frame of No. 0104 in FIG. 9D is set as the key frame and the frame is a frame in which the position coordinates of the camera cannot be acquired as shown in FIG. 9D. Because of this, in a light emission characteristics setting box 1103 shown in FIG. 11B, the radio button of “point light source” is not displayed (not selectable).

At the time of presenting the alternatives of the operation mode to a user, it may also be possible to present the operation modes that can be set in all the frames within the editing range set at step S1002 as alternatives in place of the alternatives corresponding to the key frame. The processing at steps S1006 to S1010 is the same as the processing at steps S306 to S310, and therefore, explanation is omitted.

By performing the processing control explained above, it is possible to obtain the same effect as that of the first embodiment and at the same time, to suppress a situation in which it becomes necessary to perform the editing work again from the beginning, which may occur in the case where there is a possibility that the position and orientation information on an object or a camera cannot be acquired sometimes.

It may also be possible to perform generation of alternative information dynamically in accordance with the editing range that is set at step S1002. In this case, the setting at the time of making use of the camera installation state or the position and orientation information acquired by various sensors is performed by a user via, for example, a Position and orientation information setting box 1104 on the UI shown in FIG. 11C. The setting items in the Position and orientation information setting box 1104 are the same as the setting items in the input box 802 and the input box 805.

### Third Embodiment

In the first and second embodiments, the method of setting the time of the top frame and the elapsed time from the time as the editing range is explained. In the present embodiment, the top frame and the last frame of the editing range are specified as the key frame and the position and orientation information on the virtual light is interpolated between both the frames. Due to this, the lighting parameters for each frame within the editing range are set.

The internal configuration in the present embodiment of the image processing apparatus 100 is the same as the internal configuration in the first embodiment shown in FIG. 2. Further, the operation in the present embodiment of the image processing apparatus 100 is the same as the operation in the first embodiment shown in FIG. 3. However, the processing at steps S302, S303, S306, and S307 is different. In the following, the processing at those steps is explained mainly.

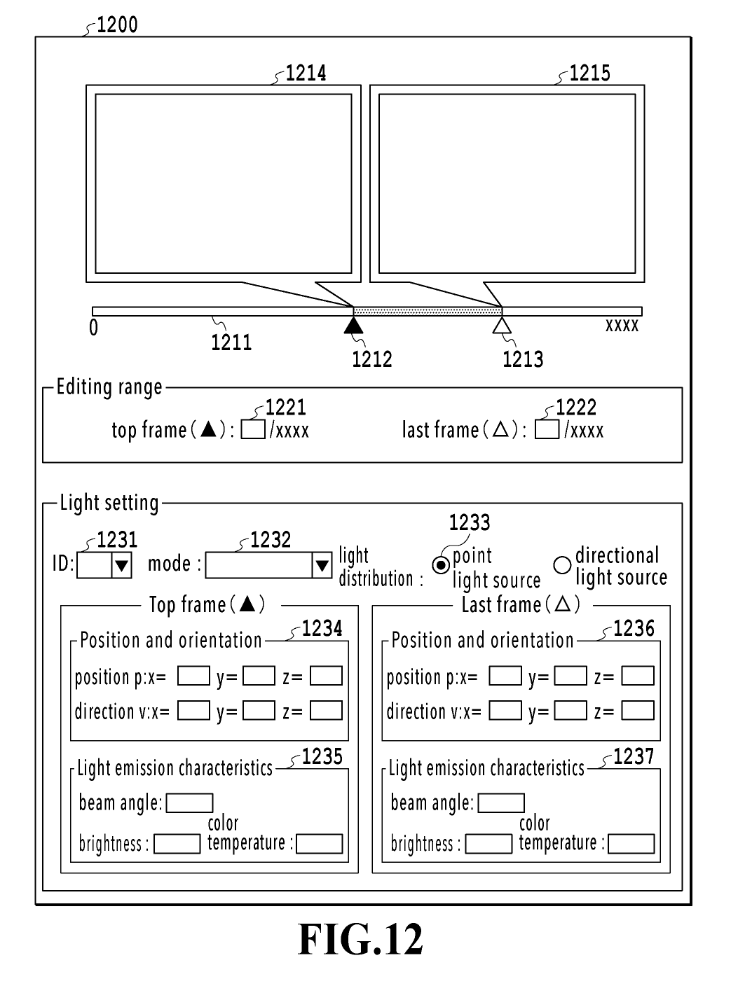

At step S302, the parameter setting unit 202 sets the editing range for the input moving image data acquired at step S301. In the present embodiment, the editing range is set by specifying time t0 of the top frame of the editing range and time te of the last frame of the editing range. FIG. 12 shows a UI screen 1200 in the present embodiment for performing parameter setting for the input moving image data. The UI screen 1200 has a last frame input box 1222 in place of the range input box 422 shown in FIG. 4A and FIG. 4B. The last frame input box 1222 is an input box for specifying the last frame in the editing range. A time axis 1211, markers 1212 and 1213, and a top frame input box 1221 shown in FIG. 12 are the same as the time axis 411, the markers 412 and 413, and the top frame input box 421 shown in FIG. 4A and FIG. 4B. The parameter setting unit 202 displays the UI screen 1200 shown in FIG. 12 on the display 110 and sets the values that are input in the top frame input box 1221 and the last frame input box 1222 as time t0 and time te, respectively.

At step S303, the parameter setting unit 202 takes the top frame and the last frame of the editing range, which are set at step S302, as the key frame and outputs image data of both the frames to the display 110. As shown in FIG. 12, the UI screen 1200 has image display boxes 1214 and 1215 in place of the image display box 414 shown in FIG. 4A and FIG. 4B. In the image display boxes 1214 and 1215, the image of the top frame and the image of the last image are displayed respectively. It may also be possible to display one of the images of the top frame and the last frame in one display box, or to display the images of both the frames in one display box by overlapping the images.

At step S306, the parameter setting unit 202 sets the lighting parameters relating to the virtual light selected at step S304. As shown in FIG. 12, the UI screen 1200 has a Position and orientation input box 1234 and a Light emission characteristics setting box 1235 corresponding to the top frame, and a Position and orientation input box 1236 and a Light emission characteristics setting box 1237 corresponding to the last frame. A virtual light selection list 1231, an operation mode selection list 1232, and a light distribution characteristics selection radio button 1233 are provided in common to the top frame and the last frame. The parameter setting unit 202 sets the values input at the light distribution characteristics selection radio button 1233, and in the Position and orientation input boxes 1234 and 1236, and the Light emission characteristics setting boxes 1235 and 1237 to the top frame and the last frame of the editing range as lighting parameters.

At step S307, the image data generation unit 203 sets lighting parameters to each frame within the editing range set at step S302 for the virtual light selected in the virtual light selection list 1231. At this time, lighting parameters are set to each frame within the editing range based on the operation mode set at step S305 and the lighting parameters set to the two key frames at step S306. Specifically, the values set as the light emission characteristics and position and orientation information are set by performing linear interpolation between each key frame. However, regarding the position and orientation information, the image data generation unit 203 finds interpolation values of the position coordinates and the direction vector in the reference coordinate system different for each operation mode. The reference coordinate system in each operation mode is the camera coordinate system in the camera reference mode, the object coordinate system in the object reference mode, and the scene coordinate system in the scene reference mode. In the following, the setting of the position and orientation information for each frame within the editing range is explained for each operation mode of the virtual light.

### Camera Reference Mode

The image data generation unit 203 performs linear interpolation in accordance with expression 9 and expression 10 below for each value of the position coordinate p (t0) and a position coordinate p (te), and the direction vector v (t0) and a direction vector v (te), which are set for the two key frames at step S306. Due to this, the position coordinate p (t) and the direction vector v (t) of the virtual light in each frame within the editing range are obtained.

p(t)=p(t0)*(te−t)/(te−t0)+p(te)*(t−t0)/(te−t0) expression (9)

v(t)=v(t0)*(te−t)/(te−t0)+v(te)*(t−t0)/(te−t0) expression (10)

### Object Reference Mode

First, the image data generation unit 203 converts the position coordinates p (t0) and p (te) and the direction vectors v (t0) and v (te) of the virtual light set for the two key frames at step 5306 into values in the object coordinate system at each time. The values after the conversion of the position coordinates of the virtual light are taken to be po (t0) and po (te). Further, the values after the conversion of the direction vectors of the virtual light are taken to be vo (t0) and vo (te).

Next, the image data generation unit 203 performs linear interpolation for those values after the conversion, respectively, and obtains the position coordinate po (t) and the direction vector vo (t) of the virtual light in each frame within the editing range. Lastly, the image data generation unit 203 converts the values of po (t) and vo (t) into those in the camera coordinate system in each frame and sets as the position coordinate p (t) and the direction vector v (t) of the virtual light in each frame.

### Scene Reference Mode

It may be possible to consider the scene reference mode by replacing the object coordinate system in the processing at the time of the object reference mode described previously with the scene coordinate system. In the present embodiment also, as in the first embodiment, the camera coordinate system at time t0 is used as the scene coordinate system.

By performing the processing control explained above, it is possible to set the way of movement of a virtual light more flexibly. At step S302, it may also be possible to present a frame whose alternatives of the operation mode change to a user as reference information at the time of setting an editing range. According to such an aspect, it is made easier for a user to grasp the range of a frame in which a desired operation mode can be set, and therefore, it is possible to suppress a situation in which is becomes necessary to set the editing range or the operation mode again from the beginning.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

By the present invention, it is possible to select the way of movement of a virtual light from a plurality of patterns and to simply set the position and orientation of a virtual light that moves in accordance with the operation mode.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-167232, filed Aug. 31, 2017, which is hereby incorporated by reference wherein in its entirety.

What is claimed is:

1. An image processing apparatus comprising:
a selection unit configured to select one operation mode from a plurality of operation modes including at least a first mode that specifies movement of a virtual light for at least one frame of a plurality of frames included in input moving image data and a second mode that specifies movement of the virtual light, which is different from the movement of the virtual light specified in the first mode;
an acquisition unit configured to acquire parameters of the virtual light based on the operation mode selected by the selection unit;
a derivation unit configured to derive parameters of the virtual light, which are set to the plurality of frames, based on the parameters of the virtual light, which are acquired by the acquisition unit; and
an execution unit configured to perform lighting processing to add illumination effects by the virtual light to each of the plurality of frames based on the parameters of the virtual light, which are derived by the derivation unit.

2. The image processing apparatus according to claim 1, further comprising:
an output unit configured to output output moving image data obtained by replacing each of the plurality of frames included in the input moving image data with each of the plurality of frames for which the lighting processing has been performed based on the parameters of the virtual light, which are derived by the derivation unit.

3. The image processing apparatus according to claim 1, wherein
the derivation unit derives the parameters of the virtual light, which are set to each of the plurality of frames, so that the position or direction of the virtual light changes on a time axis in accordance with the operation mode.

4. The image processing apparatus according to claim 1, wherein
the operation mode includes at least a camera reference mode that causes the virtual light to follow a camera, an object reference mode that causes the virtual light to follow an object, and a scene reference mode in which movement of the virtual light does not depend on movement of a camera or an object.

5. The image processing apparatus according to claim 1, further comprising:
a generation unit configured to determine the operation mode that can be set for the input moving image data by analyzing the input moving image data and to generate alternative information indicating the operation mode that can be set, wherein
the selection unit selects one operation mode from the operation modes indicated by the alternative information.

6. The image processing apparatus according to claim 5, wherein
the generation unit determines the operation mode that can be set for the input moving image data in accordance with an installation state of a camera having acquired the input moving image data by image capturing.

7. The image processing apparatus according to claim 5, wherein
the generation unit determines the operation mode that can be set for the input moving image data in accordance with whether or not it is possible to acquire information indicating a position and orientation of an object from the input moving image data.

8. The image processing apparatus according to claim 5, wherein
the generation unit determines the operation mode that can be set for the input moving image data in accordance with whether or not it is possible to acquire information indicating a position and orientation of a camera having acquired the input moving image data by image capturing from the input moving image data.

9. The image processing apparatus according to claim 1, further comprising:
a parameter setting unit configured to set parameters of the virtual light for at least one frame of the plurality of frames included in the input moving image data based on instructions of a user, wherein
the acquisition unit acquires parameters of the virtual light, for which coordinate conversion has been performed, by performing the coordinate conversion of the parameters of the virtual light, which are set by the parameter setting unit, based on an operation mode selected by the selection unit.

10. The image processing apparatus according to claim 1, wherein
a plurality of frames in succession on a time axis is taken to be a target of the lighting processing, and
the image processing apparatus further comprises a specification unit configured to specify the plurality of frames taken to be a target of the lighting processing based on instructions of a user.

11. The image processing apparatus according to claim 1, further comprising:
a display control unit configured to cause a display device to at least display a first user interface for causing a user to specify one operation mode from the plurality of operation modes and a second user interface for causing a user to specify parameters indicating a position and orientation and light emission characteristics of the virtual light as parameters of the virtual light, wherein
the selection unit selects an operation mode specified by a user via the first user interface, and
the acquisition unit acquires parameters of the virtual light, for which coordinate conversion has been performed, by performing the coordinate conversion of the parameters of the virtual light, which are specified by a user via the second user interface, based on an operation mode selected by the selection unit.

12. The image processing apparatus according to claim 11, wherein
the acquisition unit converts parameters of the virtual light from values represented in a coordinate system based on a position and orientation of a camera having acquired the input moving image data by image capturing into values represented in a coordinate system corresponding to an operation mode selected by the selection unit.

13. The image processing apparatus according to claim 12, wherein
the acquisition unit converts parameters of the virtual light into values represented in a coordinate system based on a position and orientation of an object that the virtual light is caused to follow in a case where an object reference mode in which the virtual light is caused to follow an object is selected by the selection unit.

14. The image processing apparatus according to claim 12, wherein
the acquisition unit converts parameters of the virtual light into values represented in a coordinate system based on a reference position set in a scene in a case where a scene reference mode in which movement of the virtual light does not depend on movement of the camera or object.

15. The image processing apparatus according to claim 12, wherein
the acquisition unit does not perform the coordinate conversion in a case where a camera reference mode in which the virtual light is caused to follow the camera is selected by the selection unit.

16. The image processing apparatus according to claim 11, wherein
the display control unit makes unspecifiable light emission characteristics on the second user interface, which are determined not to be able to be set as parameters of the virtual light from an operation mode specified by a user via the first user interface and information indicating a position and orientation of a camera or object that can be acquired from the input moving image data.

17. The image processing apparatus according to claim 11, wherein
a plurality of frames in succession on a time axis is taken to be a target of the lighting processing, and
the display control unit causes the display device to display a third user interface for causing a user to specify a time of a top frame of the plurality of frames taken to be a target of the lighting processing and a time having elapsed from the time.

18. The image processing apparatus according to claim 11, wherein
a plurality of frames in succession on a time axis is taken to be a target of the lighting processing, and
the display control unit causes the display device to display a fourth user interface for causing a user to specify a position on a time axis of a top frame and a last frame of the plurality of frames taken to be a target of the lighting processing.

19. An image processing method comprising the steps of:
selecting one operation mode from a plurality of operation modes including at least a first mode that specifies movement of a virtual light for at least one frame of a plurality of frames included in input moving image data and a second mode that specifies movement of the virtual light, which is different from the movement of the virtual light specified in the first mode;
acquiring parameters of the virtual light based on the selected operation mode;
deriving parameters of the virtual light, which are set to the plurality of frames, based on the acquired parameters of the virtual light; and
performing lighting processing to add illumination effects by the virtual light to each of the plurality of frames based on the derived parameters of the virtual light.

20. A non-transitory computer readable storage medium storing a program for causing a computer to perform an image processing method, the method comprising the steps of:
selecting one operation mode from a plurality of operation modes including at least a first mode that specifies movement of a virtual light for at least one frame of a plurality of frames included in input moving image data and a second mode that specifies movement of the virtual light, which is different from the movement of the virtual light specified in the first mode;
acquiring parameters of the virtual light based on the selected operation mode;
deriving parameters of the virtual light, which are set to the plurality of frames, based on the acquired parameters of the virtual light; and
performing lighting processing to add illumination effects by the virtual light to each of the plurality of frames based on the derived parameters of the virtual light.
